(19) United States
(12) Patent Application Publication
(10) Pub. No.: US 2006/0286319 A1
(43) Pub. Date: Dec. 21, 2006

(54) Beverage bottle labels for reducing heat transfer

(76) Inventors: Monte Christopher Magill, Longmont, CO (US); Jeannette Heimbach, Boulder, CO (US); Ray Alan Toms, Golden, CO (US); Timothy Henry Klein, Golden, CO (US); Scott Anthony Farkas, Otsego, MN (US)

Correspondence Address: COOLEY GODWARD KRONISH LLP, 3000 EL CAMINO REAL, 5 PALO ALTO SQUARE, PALO ALTO, CA, 94306, US

(21) Appl. No.: 11/329,827

(22) Filed: Jan. 10, 2006

Related U.S. Application Data
(60) Provisional application No. 60/692,747, filed on Jun. 21, 2005.

(51) Int. Cl. B31B 45/00

(52) U.S. Cl. 428/34.1

(57) ABSTRACT

A beverage container includes a beverage bottle and a label adjacent to the beverage bottle and including a set of microcapsules that contain a phase change material. The phase change material has a latent heat of at least 40 J/g and a transition temperature in the range of 0° C. to 40° C. The phase change material provides thermal regulation based on at least one of absorption and release of the latent heat at the transition temperature.

### CROSS-REFERENCE TO RELATED APPLICATION

This application claims the benefit of U.S. Provisional Application Ser. No. 60/692,747, filed on Jun. 21, 2005, the disclosure of which is incorporated herein by reference in its entirety.

### FIELD OF THE INVENTION

The invention generally relates to labels. For example, labels that reduce heat transfer to contents of beverage bottles are described.

### BACKGROUND OF THE INVENTION

A beverage bottle is often used for containing a beverage such as beer. Such a beverage bottle is typically kept in a refrigerator or a cooler prior to consumption, since many consumers prefer to drink cold beer. However, after the beverage bottle is removed from the refrigerator or the cooler, beer that is contained within the beverage bottle undesirably begins to warm.

Heat transfer can occur from an outside environment to contents of a beverage bottle via different modes. Typically, a primary mode of heat transfer is by conduction. In particular, if an object at a higher temperature is in contact with the beverage bottle, heat can be conducted from the object to the beverage bottle. Thus, for example, when a consumer holds the beverage bottle, heat can be conducted from the consumer's hand to the beverage bottle, thus undesirably warming beer that is contained within the beverage bottle. Other modes of heat transfer can also play a role in warming the contents of the beverage bottle. For example, convection from air surrounding the beverage bottle as well as radiation from sunlight or another light source can further accelerate warming of the contents of the beverage bottle.

It is against this background that a need arose to develop the labels for beverage bottles described herein.

### SUMMARY OF THE INVENTION

In one aspect, the invention relates to a beverage container. In one embodiment, the beverage container includes a beverage bottle and a label adjacent to the beverage bottle and including a set of microcapsules that contain a phase change material. The phase change material has a latent heat of at least 40 J/g and a transition temperature in the range of 0° C. to 40° C. The phase change material provides thermal regulation based on at least one of absorption and release of the latent heat at the transition temperature.

In another embodiment, the beverage container includes a body portion having an outer surface and defining an internal compartment to contain a beverage. The beverage container also includes a label adjacent to the outer surface of the body portion and including a substrate and a coating covering at least a portion of the substrate. The coating includes a binder and a set of microcapsules dispersed in the binder, and the set of microcapsules contain a phase change material having a latent heat in the range of 40 J/g to 400 J/g and a transition temperature in the range of 0° C. to 100° C.

In another aspect, the invention relates to a method of providing thermal regulation. In one embodiment, the method includes providing a beverage bottle to contain a beverage. The method also includes providing a label including a set of microcapsules that contain a phase change material. The phase change material has a latent heat of at least 40 J/g and a transition temperature in the range of 0° C. to 37° C. The method further includes coupling the label to the beverage bottle, such that the phase change material reduces warming of the beverage based on at least one of absorption and release of the latent heat at the transition temperature.

Other aspects and embodiments of the invention are also contemplated. For example, other aspects of the invention relate to a label for a beverage bottle, a method of forming such a label, and a method of forming a beverage container that includes such a label. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a beverage container implemented in accordance with an embodiment of the invention.

FIG. 2 illustrates a label for a beverage bottle, according to an embodiment of the invention.

FIG. 3 illustrates results of temperature measurements for glass bottles that are coupled to different labels, according to an embodiment of the invention.

### DETAILED DESCRIPTION

### Overview

Embodiments of the invention relate to labels for beverage bottles. Labels in accordance with various embodiments of the invention can provide thermal regulation by reducing heat transfer between an outside environment and contents of beverage bottles. In particular, the labels can include phase change materials, so that the labels have the ability to absorb or release heat to reduce or eliminate heat transfer. In such manner, the contents of the beverage bottles can be maintained at a desired temperature or within a desired range of temperatures for a prolonged period of time. In conjunction with providing thermal regulation, the labels can provide other desired functionality, such as serving as a display element to convey information related to the beverage bottles.

### Definitions

The following definitions apply to some of the elements described with respect to some embodiments of the invention. These definitions may likewise be expanded upon herein.

As used herein, the singular terms “a,” “an,” and “the” include plural referents unless the context clearly dictates otherwise. Thus, for example, reference to a phase change material can include multiple phase change materials unless the context clearly dictates otherwise.

As used herein, the term “set” refers to a collection of one or more elements. Thus, for example, a set of microcapsules can include a single microcapsule or multiple microcapsules. Elements of a set can also be referred to as members of the set. Elements of a set can be the same or different. In some instances, elements of a set can share one or more common characteristics.

As used herein, the term “adjacent” refers to being near or adjoining. Objects that are adjacent can be spaced apart from one another or can be in actual or direct contact with one another. In some instances, objects that are adjacent can be coupled to one another or can be formed integrally with one another.

As used herein, the terms “integral” and “integrally” refer to a non-discrete portion of an object. Thus, for example, a beverage bottle including a neck portion and a body portion that is formed integrally with the neck portion can refer to an implementation of the beverage bottle in which the neck portion and the body portion are formed as a monolithic unit. An integrally formed portion of an object can differ from one that is coupled to the object, since the integrally formed portion of the object typically does not form an interface with a remaining portion of the object.

As used herein, the term “size” refers to a largest dimension of an object. Thus, for example, a size of a spheroid can refer to a major axis of the spheroid. As another example, a size of a sphere can refer to a diameter of the sphere.

As used herein, the term “latent heat” refers to an amount of heat absorbed or released by a substance (or a mixture of substances) as it undergoes a transition between two states. Thus, for example, a latent heat can refer to an amount of heat that is absorbed or released as a substance (or a mixture of substances) undergoes a transition between a liquid state and a solid state, a liquid state and a gaseous state, a solid state and a gaseous state, or two solid states.

As used herein, the term “transition temperature” refers to a temperature at which a substance (or a mixture of substances) undergoes a transition between two states. Thus, for example, a transition temperature can refer to a temperature at which a substance (or a mixture of substances) undergoes a transition between a liquid state and a solid state, a liquid state and a gaseous state, a solid state and a gaseous state, or two solid states.

As used herein, the term “phase change material” refers to a substance (or a mixture of substances) that has the capability of absorbing or releasing heat to reduce or eliminate heat transfer at or within a temperature stabilizing range. A temperature stabilizing range can include a specific transition temperature or a range of transition temperatures. In some instances, a phase change material can be capable of inhibiting heat transfer during a period of time when the phase change material is absorbing or releasing heat, typically as the phase change material undergoes a transition between two states. This action is typically transient and will occur until a latent heat of the phase change material is absorbed or released during a heating or cooling process. Heat can be stored or removed from a phase change material, and the phase change material typically can be effectively recharged by a source of heat or cold. For certain implementations, a phase change material can be a solid/solid phase change material. A solid/solid phase change material is a type of phase change material that typically undergoes a transition between two solid states, such as via a crystalline or mesocrystalline phase transformation, and hence typically does not become a liquid during use. For certain implementations, a phase change material can be a mixture of two or more substances. By selecting two or more different substances and forming a mixture, a temperature stabilizing range can be adjusted for any desired application. The resulting mixture can exhibit two or more different transition temperatures or a single modified transition temperature when incorporated in a label described herein.

Examples of phase change materials include a variety of organic and inorganic substances, such as hydrocarbons (e.g., straight chain alkanes or paraffinic hydrocarbons, branched-chain alkanes, unsaturated hydrocarbons, halogenated hydrocarbons, and alicyclic hydrocarbons), hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids, fatty acid esters, dibasic acids, dibasic esters, 1-halides, primary alcohols, aromatic compounds, clathrates, semi-clathrates, gas clathrates, anhydrides (e.g., stearic anhydride), ethylene carbonate, polyhydric alcohols (e.g., 2,2-dimethyl-1,3-propanediol, 2-hydroxymethyl-2-methyl-1,3-propanediol, ethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), metals, and mixtures thereof.

As used herein, the term “polymer” refers to a substance (or a mixture of substances) that includes a set of macromolecules. Macromolecules included in a polymer can be the same or can differ from one another in some fashion. A macromolecule can have any of a variety of skeletal structures, and can include one or more types of monomer units. In particular, a macromolecule can have a skeletal structure that is linear or non-linear. Examples of non-linear skeletal structures include branched skeletal structures, such those that are star branched, comb branched, or dendritic branched, and network skeletal structures. A macromolecule included in a homopolymer typically includes one type of monomer unit, while a macromolecule included in a copolymer typically includes two or more types of monomer units. Examples of copolymers include statistical copolymers, random copolymers, alternating copolymers, periodic copolymers, block copolymers, radial copolymers, and graft copolymers. In some instances, a reactivity and a functionality of a polymer can be altered by addition of a functional group such as an amine, an amide, a carboxyl, a hydroxyl, an ester, an ether, an epoxide, an anhydride, an isocyanate, a silane, a ketone, an aldehyde, or an unsaturated group. Also, a polymer can be capable of cross-linking, entanglement, or hydrogen bonding in order to increase its mechanical strength or its resistance to degradation under ambient or processing conditions.

Examples of polymers include polyamides, polyamines, polyimides, polyacrylics (e.g., polyacrylamide, polyacrylonitrile, and esters of methacrylic acid and acrylic acid), polycarbonates (e.g., polybisphenol A carbonate and polypropylene carbonate), polydienes (e.g., polybutadiene, polyisoprene, and polynorbornene), polyepoxides, polyesters (e.g., polycaprolactone, polyethylene adipate, polybutylene adipate, polypropylene succinate, polyesters based on terephthalic acid, and polyesters based on phthalic acid), polyethers (e.g., polyethylene glycol or polyethylene oxide, polybutylene glycol, polypropylene oxide, polyoxymethylene or paraformaldehyde, polytetramethylene ether or polytetrahydrofuran, and polyepichlorohydrin), polyfluorocarbons, formaldehyde polymers (e.g., urea-formaldehyde, melamine-formaldehyde, and phenol formaldehyde), natural polymers (e.g., cellulosics, chitosans, lignins, and waxes), polyolefins (e.g., polyethylene, polypropylene, polybutylene, polybutene, and polyoctene), polyphenylenes, silicon containing polymers (e.g., polydimethyl siloxane and polycarbomethyl silane), polyurethanes, polyvinyls (e.g., polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, and polyvinyl methyl ketone), polyacetals, polyarylates, alkyd based polymers (e.g., polymers based on glyceride oil), copolymers (e.g., polyethylene-co-vinyl acetate and polyethylene-co-acrylic acid), and mixtures thereof.

### Beverage Container

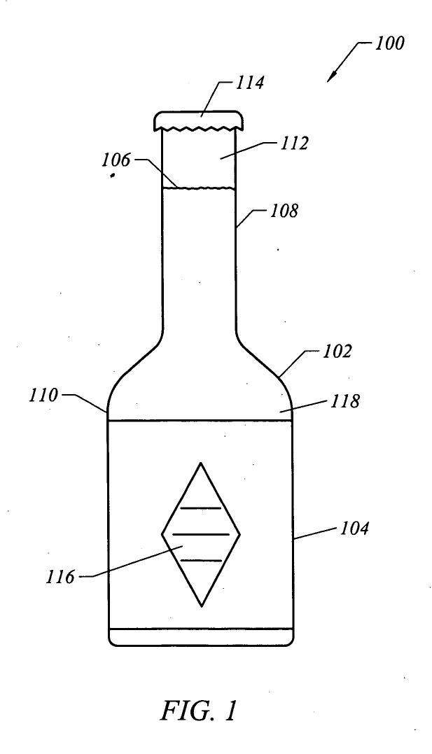

Attention first turns to FIG. 1, which illustrates a beverage container 100 implemented in accordance with an embodiment of the invention. The beverage container 100 includes a beverage bottle 102 and a label 104 that is adjacent to the beverage bottle 102. In the illustrated embodiment, the label 104 is coupled to an outer surface 118 of the beverage bottle 102 using any suitable fastening mechanism, such as using a pressure-sensitive adhesive.

In the illustrated embodiment, the beverage bottle 102 is implemented to contain a beverage 106, which can be, for example, an alcoholic beverage such as beer. As can be appreciated, beer is a type of alcoholic beverage that is produced from fermentation of grains, such as malted barley, and is typically flavored with hops. Examples of beer include lager, ale, porter, and stout. Referring to FIG. 1, the beverage bottle 102 includes a neck portion 108 and a body portion 110 that is formed integrally with the neck portion 108. The neck portion 108 and the body portion 110 define an internal compartment 112 within which the beverage 106 is positioned. In the illustrated embodiment, at least one of the neck portion 108 and the body portion 110 is formed of a translucent or transparent material, such as a glass, so that a consumer can view the beverage 106 that is contained within the beverage bottle 102. The selection of the material forming the beverage bottle 102 can also be dependent upon other considerations, such as to prolong a shelf-life of the beverage 106. As illustrated in FIG. 1, the beverage bottle 102 also includes a cap 114, which is formed of any suitable material, such as a metal or a polymer. The cap 114 is coupled to an end of the neck portion 108 using any suitable fastening mechanism, thus sealing the beverage 106 within the beverage bottle 102 prior to consumption.

As illustrated in FIG. 1, the label 104 is implemented as a display element to convey information related to the beverage bottle 102. In particular, the label 104 includes indicia 116 to convey information related to the beverage 106 or related to a manufacturer or another source of the beverage container 100. Advantageously, the label 104 is also implemented to provide thermal regulation by reducing heat transfer between an outside environment and the beverage 106 that is contained within the beverage bottle 102. In particular, after the beverage container 100 is removed from a refrigerator or a cooler, the beverage 106 has an undesirable tendency to warm up via one or more modes of heat transfer, and the label 104 is implemented to counteract this undesirable tendency.

In the illustrated embodiment, the label 104 is formed so as to include a phase change material, which serves to absorb or release heat to reduce or eliminate heat transfer across the label 104. Thus, for example, as a consumer holds the beverage container 100 during use, the phase change material can absorb heat that would otherwise be conducted from the consumer's hand to the beverage 106. In such manner, the beverage 106 can be maintained at a relatively low temperature or a relatively low range of temperatures for a prolonged period of time. Advantageously, the use of the phase change material allows the label 104 to provide thermal regulation on an “as-needed” basis. In particular, since the consumer may intermittently hold the beverage container 100, the phase change material can absorb heat primarily during those periods of time when the consumer is actually holding the beverage container 100. The phase change material can then release heat back to the outside environment during those periods of time when the consumer is not actually holding the beverage container 100.

The use of specific materials and other specific implementation features can further enhance thermal regulating characteristics of the label 104. For example, as further described below, a transition temperature, a loading level, and positioning of the phase change material can contribute to the thermal regulating characteristics of the label 104. As another example, dimensions of the label 104 can be selected so as to provide sufficient coverage of the outer surface 118 of the beverage bottle 102. Referring to FIG. 1, a longitudinal dimension of the label 104 can be selected so that the label 104 substantially encircles an outer circumference of the body portion 110. As can be appreciated, such implementation of the label 104 can be referred to as a “360° wrap.” In such manner, the label 104 can provide sufficient coverage of those portions of the outer surface 118 that are typically in contact with a consumer's hand during use. It is also contemplated that a transverse dimension of the label 104 can be extended so as to cover at least a portion of the neck portion 108. It is further contemplated that a separate label (not illustrated in FIG. 1) can be included so as to cover the neck portion 108. Such a separate label can be implemented in a similar fashion as the label 104.

### Label for Beverage Bottle

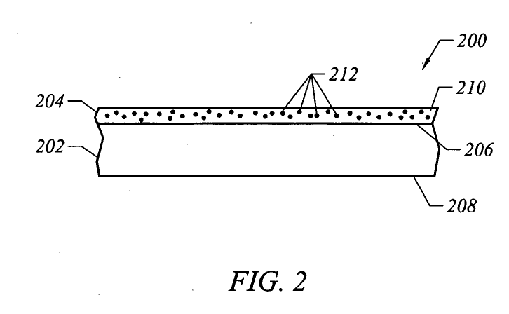

The foregoing provides a general overview of an embodiment of the invention. Attention next turns to FIG. 2, which illustrates a label 200 for a beverage bottle, according to an embodiment of the invention. In particular, FIG. 2 illustrates a side, sectional view of the label 200, which includes a first layer 202 and a second layer 204 that is adjacent to the first layer 202.

In the illustrated embodiment, the first layer 202 is implemented as a film or a sheet, and is formed of any suitable material, such as a fibrous material or a polymer. Thus, for example, the first layer 202 can be formed of a paper, a polyester, a polyolefin such as polyethylene or polypropylene, or a polyvinyl. The selection of a material forming the first layer 202 can be dependent upon other considerations, such as its ability to facilitate formation of the second layer 204, its ability to reduce or eliminate heat transfer, its flexibility, its film-forming or sheet-forming ability, its resistance to degradation under ambient or processing conditions, and its mechanical strength. As illustrated in FIG. 2, the first layer 202 serves as a substrate, and the material forming the first layer 202 can be selected based on its ability to facilitate formation of the second layer 204 adjacent to the first layer 202. While not illustrated in FIG. 2, it is contemplated that the first layer 202 can be formed so as to include two or more sub-layers, which can be formed of the same material or different materials. For certain implementations, at least one of the sub-layers can be formed of a metal, such as in the form of a coating of the metal. As can be appreciated, such implementation of the first layer 202 can be referred to as a “metallized” film or sheet. Such metallized film or sheet can be desirable, since a coating of a metal can provide enhanced mechanical strength as well as serve to reflect heat from sunlight or another light source, thus reducing heat transfer across the label 200. It is also contemplated that the first layer 202 can be formed so as to include a set of internal compartments that contain an insulation material, such as in the form of air pockets. As can be appreciated, such implementation of the first layer 202 can be referred to as a “cavitated” film or sheet. Such cavitated film or sheet can be desirable, since the air pockets can serve to further reduce heat transfer across the label 200.

As illustrated in FIG. 2, the second layer 204 is implemented as a coating that is formed adjacent to the first layer 202 using any suitable coating or printing technique. Referring to FIG. 2, the second layer 204 covers at least a portion of a top surface 206 of the first layer 202. Depending on characteristics of the first layer 202 or a specific coating or printing technique used, the second layer 204 can penetrate below the top surface 206 and permeate at least a portion of the first layer 202. While two layers are illustrated in FIG. 2, it is contemplated that the label 200 can include more or less layers for other implementations. In particular, it is contemplated that a third layer (not illustrated in FIG. 2) can be included so as to cover at least a portion of a bottom surface 208 of the first layer 202. Such a third layer can be implemented in a similar fashion as the second layer 204.

In the illustrated embodiment, the second layer 204 is formed of a binder 210 and a set of microcapsules 212 that are dispersed in the binder 210. The binder 210 can be any suitable material that serves as a matrix within which the microcapsules 212 are dispersed, and that couples the microcapsules 212 to the first layer 202. The binder 210 can provide other desired functionality, such as offering a degree of protection to the microcapsules 212 against ambient or processing conditions or against abrasion or wear during use. For example, the binder 210 can be a polymer or an ink medium used in certain printing techniques. The selection of the binder 210 can be dependent upon other considerations, such as based on its affinity for the microcapsules 212, its ability to reduce or eliminate heat transfer, its flexibility, its coating-forming ability, its resistance to degradation under ambient or processing conditions, and its mechanical strength. Thus, for example, the binder 210 can be selected based on its affinity for the microcapsules 212 so as to facilitate dispersion of the microcapsules 212 within the binder 210. Such affinity can be dependent upon, for example, similarity in polarities, hydrophobic characteristics, or hydrophilic characteristics of the binder 210 and a material forming the microcapsules 212. For example, the binder 210 can be selected to be the same as or similar to a material forming the microcapsules 212. Advantageously, such affinity can facilitate incorporation of a higher loading level as well as a more uniform distribution of the microcapsules 212 within the second layer 204. In addition, a smaller amount of the binder 210 can be required to incorporate a desired loading level of the microcapsules 212, thus allowing for a reduced thickness of the second layer 204 and improved flexibility of the label 200.

Referring to FIG. 2, the microcapsules 212 are implemented to contain a phase change material, which serves to absorb or release heat to reduce or eliminate heat transfer across the label 200. In the illustrated embodiment, the microcapsules 212 are formed as shells that define internal compartments within which the phase change material is positioned. The microcapsules 212 can be formed of any suitable material that serves to contain the phase change material, thus offering a degree of protection to the phase change material against ambient or processing conditions or against loss or leakage during use. For example, the microcapsules 212 can be formed of a polymer or any other suitable encapsulation material. For certain implementations, the microcapsules 212 can be formed of gelatin or gum arabic in a water-based complex coacervation system, or the microcapsules 212 can be formed of melamine-formaldehyde or urea-formaldehyde by in-situ polymerization. The selection of a material forming the microcapsules 212 can be dependent upon other considerations, such as based on its affinity for the binder 210, its reactivity or lack of reactivity with the phase change material, its resistance to degradation under ambient or processing conditions, and its mechanical strength. The microcapsules 212 can have the same shape or different shapes, and can have the same size or different sizes. In some instances, the microcapsules 212 can be substantially spheroidal or spherical, and can have sizes ranging from about 0.01 to about 4,000 microns, such as from about 0.1 to about 1,000 microns, from about 0.1 to about 500 microns, from about 0.1 to about 100 microns, or from about 0.5 to about 50 microns. Thus, for example, the microcapsules 212 can have sizes ranging from about 15 to about 25 microns.

The selection of the phase change material can be dependent upon a latent heat and a transition temperature of the phase change material. A latent heat of the phase change material typically correlates with its ability to reduce or eliminate heat transfer. In some instances, the phase change material can have a latent heat that is at least about 40 J/g, such as at least about 50 J/g, at least about 60 J/g, at least about 70 J/g, at least about 80 J/g, at least about 90 J/g, or at least about 100 J/g. Thus, for example, the phase change material can have a latent heat ranging from about 40 J/g to about 400 J/g, such as from about 60 J/g to about 400 J/g, from about 80 J/g to about 400 J/g, or from about 100 J/g to about 400 J/g. A transition temperature of the phase change material typically correlates with a desired temperature or a desired range of temperatures that can be maintained by the phase change material. In some instances, the phase change material can have a transition temperature ranging from about 0° C. to about 100° C., such as from about 0° C. to about 50° C., from about 0° C. to about 40° C., or from about 0° C. to about 37° C. For maintaining a beverage at relatively low temperatures for a prolonged period of time, it has been discovered that a transition temperature that is within a specific range below normal skin temperature can be particularly desirable. In particular, a transition temperature desirably ranges from about 25° C. to about 35° C., such as from about 27° C. to about 29° C. The selection of the phase change material can be dependent upon other considerations, such as its reactivity or lack of reactivity with a material forming the microcapsules 212 and its resistance to degradation under ambient or processing conditions.

For certain implementations, the phase change material can include a paraffinic hydrocarbon having n carbon atoms, namely a Cₙ paraffinic hydrocarbon with n being a positive integer. Table 1 provides a list of C₁₄-C₂₀ paraffinic hydrocarbons that can be used as the phase change material. As can be appreciated, the number of carbon atoms of a paraffinic hydrocarbon typically correlates with its melting point. For example, n-Eicosane, which includes 20 straight chain carbon atoms per molecule, has a melting point of 36.8° C. By comparison, n-Tetradecane, which includes 14 straight chain carbon atoms per molecule, has a melting point of 5.9° C.

TABLE 1

| | No. of | Melting |
|---|---|---|
| | Carbon | Point |
| Paraffinic Hydrocarbon | Atoms | (° C.) |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |

Depending upon specific characteristics desired for the label 200, the second layer 204 can cover from about 1 to about 100 percent of the top surface 206 of the first layer 202. Thus, for example, the second layer 204 can cover from about 20 to about 100 percent, from about 50 to about 100 percent, or from about 80 to about 100 percent of the top surface 206. When thermal regulating characteristics of the label 200 are a controlling consideration, the second layer 204 can cover a larger percentage of the top surface 206. On the other hand, when other characteristics of the label 200 are a controlling consideration, the second layer 204 can cover a smaller percentage of the top surface 206. Alternatively, or in conjunction, when balancing thermal regulating and other characteristics of the label 200, it can be desirable to adjust a thickness of the second layer 204 or a loading level of the microcapsules 212 within the second layer 204.

For certain implementations, the second layer 204 can have a loading level of the microcapsules 212 ranging from about 1 to about 100 percent by dry weight of the microcapsules 212. Thus, for example, the second layer 204 can have a loading level ranging from about 20 to about 80 percent, from about 20 to about 50 percent, or from about 25 to about 35 percent by dry weight of the microcapsules 212. When thermal regulating characteristics of the label 200 are a controlling consideration, the second layer 204 can have a higher loading level of the microcapsules 212. On the other hand, when other characteristics of the label 200 are a controlling consideration, the second layer 204 can have a lower loading level of the microcapsules 212. Alternatively, or in conjunction, when balancing thermal regulating and other characteristics of the label 200, it can be desirable to adjust a thickness of the second layer 204 or a percentage of the top surface 206 that is covered by the second layer 204. It is also contemplated that the second layer 204 can be formed so as to include an additional set of microcapsules (not illustrated in FIG. 2) that are dispersed in the binder 210. Such additional microcapsules can differ in some fashion from the microcapsules 212, such as by having different shapes or sizes or by containing a different phase change material.

In some instances, the second layer 204 can be formed so as to provide substantially uniform characteristics across the top surface 206 of the first layer 202. Thus, as illustrated in FIG. 2, the microcapsules 212 are substantially uniformly distributed within the second layer 204. Such uniformity in distribution of the microcapsules 212 can serve to inhibit heat from being preferentially and undesirably conducted across a portion of the label 200 that includes a lesser density of the microcapsules 212 than another portion. Such uniformity in distribution can also provide a more even “feel” to the label 200. However, depending upon specific characteristics desired for the label 200, the distribution of the microcapsules 212 can be varied within one or more portions of the second layer 204. Thus, for example, the microcapsules 212 can be concentrated in one or more portions of the second layer 204 or distributed in accordance with a concentration profile along one or more directions within the second layer 204.

During formation of the label 200, an aqueous or non-aqueous blend can be formed by mixing the binder 210 with the microcapsules 212, which can be provided in a dry, powdered form. In some instances, a set of additives can be added when forming the blend. For example, a surfactant can be added to decrease interfacial surface tension and to promote wetting of the microcapsules 212, or a dispersant can be added to promote uniform dispersion or incorporation of a higher loading level of the microcapsules 212. As another example, a thickener can be added to adjust a viscosity of the blend, or an anti-foam agent can be added to remove any trapped air bubbles that are formed during mixing. Once formed, the blend can be applied to or deposited on the top surface 206 of the first layer 202 using any suitable coating or printing technique. Thus, for example, the blend can be applied using roll coating, such as direct gravure coating, reverse gravure coating, differential offset gravure coating, or reverse roll coating; screen coating; spray coating, such as air atomized spraying, airless atomized spraying, or electrostatic spraying; extrusion coating; or transfer coating. After the blend is applied to the top surface 206, the blend can be cured, dried, cross-linked, reacted, or solidified to form the second layer 204.

Once formed, the label 200 can be coupled to a beverage bottle using any suitable fastening mechanism, such as using a pressure-sensitive adhesive. In particular, the label 200 can be positioned so that the second layer 204 is adjacent to an outer surface of the beverage bottle. Such positioning is desirable so as to offer a degree of protection to the microcapsules 212 against ambient or processing conditions or against abrasion or wear during use. However, it is contemplated that the label 200 can be positioned so that the second layer 204 is exposed to an outside environment.

### Example

The following example describes specific features of an embodiment of the invention to illustrate and provide a description for those of ordinary skill in the art. The example should not be construed as limiting the invention, as the example merely provides specific methodology useful in understanding and practicing one embodiment of the invention.

Five different labels for glass bottles were provided. Two of these labels, namely label A and label B, were formed so as to include microcapsules containing a phase change material. In particular, label A was formed with a coating that included about 50% by dry weight of the microcapsules, while label B was formed with a coating that included about 30% by dry weight of the microcapsules. The remaining three labels, namely label C, label D, and label E, lacked the microcapsules and served as control labels. In particular, label C was a plain, 360° wrap label, label D was a plain, pressure-sensitive label, and label E was a standard, non-360° wrap label. These labels were coupled to respective glass bottles, and the glass bottles were then filled with substantially equal amounts of water.

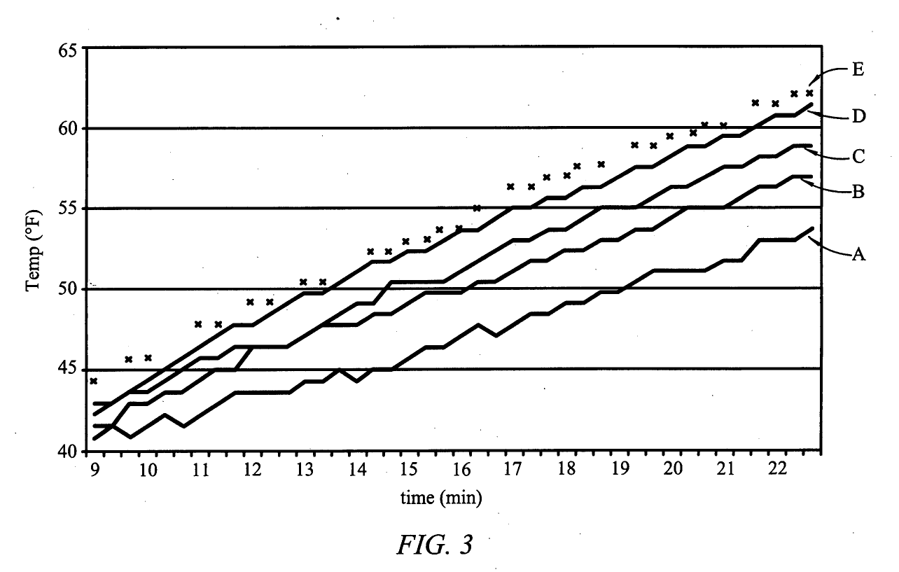

Temperature measurements of contents of the glass bottles were made in accordance with a test protocol, which involved intermittently holding the glass bottles to simulate conditions during use. In particular, the test protocol involved alternating a “hands-on” period of about 10 seconds and a “hands-off” period of about 20 seconds for a total duration of up to about 30 minutes. Referring to FIG. 3, results of the temperature measurements for the five different labels are shown as a function of time. As can be appreciated by referring to FIG. 3, the contents of the glass bottles coupled to label A and label B exhibited reduced warming as compared with the contents of the glass bottles coupled to the control labels.

One of ordinary skill in the art requires no additional explanation in developing the labels described herein but may nevertheless find some helpful guidance regarding formation of microcapsules by examining the following references: Tsuei et al., U.S. Pat. No. 5,589,194, entitled “Method of Encapsulation and Microcapsules Produced Thereby;” Tsuei, et al., U.S. Pat. No. 5,433,953, entitled “Microcapsules and Methods for Making Same;” Hatfield, U.S. Pat. No. 4,708,812, entitled “Encapsulation of Phase Change Materials;” and Chen et al., U.S. Pat. No. 4,505,953, entitled “Method for Preparing Encapsulated Phase Change Materials;” the disclosures of which are herein incorporated by reference in their entireties.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while the methods disclosed herein may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A beverage container, comprising:
a beverage bottle; and
a label adjacent to the beverage bottle and including a plurality of microcapsules that contain a phase change material, the phase change material having a latent heat of at least 40 J/g and a transition temperature in the range of 0° C. to 40° C., the phase change material providing thermal regulation based on at least one of absorption and release of the latent heat at the transition temperature.

2. The beverage container of claim 1, wherein the latent heat of the phase change material is at least 50 J/g.

3. The beverage container of claim 1, wherein the latent heat of the phase change material is at least 60 J/g.

4. The beverage container of claim 1, wherein the transition temperature of the phase change material is in the range of 0° C. to 37° C.

5. The beverage container of claim 1, wherein the transition temperature of the phase change material is in the range of 25° C. to 35° C.

6. The beverage container of claim 1, wherein the transition temperature of the phase change material is in the range of 27° C. to 29° C.

7. The beverage container of claim 1, wherein the phase change material includes a paraffinic hydrocarbon having from 14 to 20 carbon atoms.

8. The beverage container of claim 1, wherein the label includes:
a substrate; and
a coating covering at least a portion of the substrate and including a binder and the plurality of microcapsules dispersed in the binder.

9. The beverage container of claim 8, wherein the beverage bottle has an outer surface, and the coating is adjacent to the outer surface of the bottle.

10. The beverage container of claim 8, wherein the coating includes from 20% to 50% by dry weight of the plurality of microcapsules containing the phase change material.

11. The beverage container of claim 8, wherein the coating includes from 25% to 35% by dry weight of the plurality of microcapsules containing the phase change material.

12. A beverage container, comprising:
a body portion having an outer surface and defining an internal compartment to contain a beverage; and
a label adjacent to the outer surface of the body portion and including:
a substrate; and
a coating covering at least a portion of the substrate and including a binder and a plurality of microcapsules dispersed in the binder, the plurality of microcapsules containing a phase change material having a latent heat in the range of 40 J/g to 400 J/g and a transition temperature in the range of 0° C. to 100° C.

13. The beverage container of claim 12, wherein the substrate includes a metallized film.

14. The beverage container of claim 12, wherein the substrate includes a cavitated film.

15. The beverage container of claim 12, wherein the phase change material reduces heat transfer across the label based on at least one of absorption and release of the latent heat at the transition temperature.

16. The beverage container of claim 12, wherein the latent heat of the phase change material is in the range of 60 J/g to 400 J/g.

17. The beverage container of claim 12, wherein the transition temperature of the phase change material is in the range of 0° C. to 37° C.

18. The beverage container of claim 12, wherein the transition temperature of the phase change material is in the range of 25° C. to 35° C.

19. The beverage container of claim 12, wherein the coating is adjacent to the outer surface of the body portion.

20. The beverage container of claim 12, wherein the coating includes from 20% to 50% by dry weight of the plurality of microcapsules containing the phase change material.

21. The beverage container of claim 12, wherein the plurality of microcapsules have sizes in the range of 0.5 microns to 50 microns.

22. The beverage container of claim 12, wherein the plurality of microcapsules have sizes in the range of 15 microns to 25 microns.

23. The beverage container of claim 12, wherein the plurality of microcapsules and the phase change material correspond to a first plurality of microcapsules and a first phase change material, respectively, and the coating further includes a second plurality of microcapsules dispersed in the binder, the second plurality of microcapsules containing a second phase change material having a latent heat in the range of 40 J/g to 400 J/g and a transition temperature in the range of 0° C. to 100° C.

24. A method of providing thermal regulation, comprising:
providing a beverage bottle to contain a beverage;
providing a label including a plurality of microcapsules that contain a phase change material, the phase change material having a latent heat of at least 40 J/g and a transition temperature in the range of 0° C. to 37° C.; and
coupling the label to the beverage bottle, such that the phase change material reduces warming of the beverage based on at least one of absorption and release of the latent heat at the transition temperature.

25. The method of claim 24, wherein the latent heat of the phase change material is at least 60 J/g.

26. The method of claim 24, wherein the transition temperature of the phase change material is in the range of 25° C. to 35° C.

27. The method of claim 24, wherein the phase change material includes a paraffinic hydrocarbon having from 14 to 20 carbon atoms.
